(19) United States
(12) Patent Application Publication
(10) Pub. No.: US 2012/0212937 A1
(43) Pub. Date: Aug. 23, 2012

(54) Reflector with fastening device for animal collars

(75) Inventors: Uwe Müller, Leverkusen (DE); Liska Vehling, Cernex (FR); Ingrid Steiner, Renchen (DE)

(73) Assignee: BAYER ANIMAL HEALTH GMBH, LEVERKUSEN (DE)

(21) Appl. No.: 13/394,529

(22) PCT Filed: Sep. 6, 2010
(86) PCT No.: PCT/EP2010/063016

§ 371 Date: Apr. 27, 2012

(30) Foreign Application Priority Data
Sep. 11, 2009 (DE) 10 2009 029 361.2

(51) Int. Cl. F21V 21/08; F21V 7/04; F21V 7/00

(52) U.S. Cl. 362/103; 362/341; 362/347

(57) ABSTRACT

The invention comprises a reflector with a fastening device for an animal collar. The reflector includes a base plate with an inner surface and an outer surface. A clip, which is substantially U-shaped, runs over the inner surface, the end of the first leg of the clip being fastened by means of a movable connection to a first side of the base plate, and the end of the second leg being suitable for being irreversibly fastened to a side of the base plate opposite from the first side. On the outer surface of the base plate there are triple prisms. On the inner surface of the base plate there is/are one or more spacers. The invention also comprises a collar containing an active substance which can leave the collar over the entire length. At least one of the reflectors according to the invention is fastened to the collar. The invention also comprises a system comprising a collar containing an active substance which can leave the collar over the entire length and at least one of the reflectors according to the invention.

The invention relates to a reflector with a fastening device for animal collars and to animal collars which contain an active substance in combination with the reflector according to the invention.

Animal collars which contain active substances and have a reflective material over their full surface area are known, for example, from FR 2 594 001, BE 904 548, DE 3242741 A1, EP 0076038 B1, U.S. Pat. No. 4,091,766 and US 2006/0144345 A1. A disadvantage of these is low concentration of the light beam and consequently weak reflection. The full-area reflective coating on collars from the prior art is not scratch-resistant and is degraded by chemical action or mechanical stress. Also known are animal collars which have one or more separate reflectors, for example JP 2000-14268, DE 2951066, DE 198606760 U, DE 1985348624 U. A disadvantage is that reflection in all directions is not ensured. Furthermore, it is not possible to rule out the chance that, during the use of collars containing an active substance, the reflectors described may impair release of the active substance. Known reflectors can he removed again from the collar. In cases where the reflectors are fastened in advance to collars containing an active substance, this entails the risk of contaminated reflectors becoming available and getting into the hands, or mouths, of children.

To increase human and animal safety, the object is to provide reflectors for an animal collar that do not have the disadvantages described above.

The object of the invention is achieved by a reflector with a fastening device for an animal collar including a base plate with an inner surface and an outer surface. A clip, which is substantially U-shaped, runs over the inner surface, the end of the first leg of the clip being fastened by means of a movable connection to a first side of the base plate, and the end of the second leg being suitable for being irreversibly fastened to a side of the base plate opposite from the first side. On the outer surface of the base plate there is/are one or more spacers.

A retroreflector is a mirror consisting of glass or transparent plastic on the rear side of which there are triple prisms. A triple prism comprises three non-reflective planar surfaces that are perpendicular to one another. The light impinging through the mirror is totally reflected at the triple prisms and returned virtually completely in the direction of the light source.

The use of triple prisms allows reflection back to the radiation source to take place largely independently of the alignment of the reflector. Furthermore, a more intensive reflection of the concentrated light beam is possible by the triple prisms than in the case of full-area coated reflector strips such as those described in the prior art.

With preference, the triple prisms are arranged in a frame which joins flush with the periphery of the base plate. The triple prisms are arranged along a reflector surface. The reflector surface is curved or segmented in a direction perpendicular to the path of the clip. The reflector surface runs over the outer surface of the base plate and has the greatest distance from the outer surface of the base plate in the middle with respect to the path perpendicular to the clip. With preference, the reflector surface comprises a middle part, which runs parallel to the base plate, and two side surfaces, which are symmetrical to each other, laterally join the middle part and taper at an angle of 60° from the connecting point to the base plate.

The triple prisms are made of thermoplastic material, such as for example polycarbonate, polymethyl methacrylate, polypropylene or polyamide, and are therefore scratch-resistant and resistant to chemical action and mechanical loading.

The object of the invention is also achieved by an animal collar containing an active substance which can leave the animal collar over the entire length. With preference, the active substance is an insecticide, with particular preference an agent against fleas or ticks. With preference, the collar consists of plastic with an embedded active substance which is released by motion; with particular preference, the plastic is PVC. At least one, with preference three, with particular preference four, of the reflectors according to the invention is/are fastened to the collar.

If three reflectors are fastened, they are spaced apart from one another when the collar is closed with preference in the range from 100 to 140 degrees, with particular preference in the range from 118 to 122 degrees. If four reflectors are fastened, they are spaced apart when the collar is closed with preference in the range from 80 to 100 degrees, with particular preference in the range from 88 to 92 degrees.

The reflectors are non-reversibly fastened to the collar.

The spacers on the inner side of the base area allow the active substance to diffuse out of the collar unhindered. With preference, the spacers are configured in such a way that they prevent the reflector from slipping on the collar, for example as nubs.

The object of the invention is also achieved by a system comprising a collar described above containing an active substance which can leave the collar over the entire length and, with preference, is an insecticide, with particular preference an agent against fleas or ticks, and at least one, with preference three, with particular preference four, of the reflectors according to the invention.

The reflector according to the invention is provided with retroreflective properties and can be fastened to a collar containing an active substance without the effectiveness of the animal collar containing an active substance being significantly impaired. Reflection in all directions from the collar is obtained, without the entire collar being coated with reflective materials over its full surface area, as a result of the triple prisms, and in particular when 3 or 4 of the reflectors according to the invention are used. Consequently, the safety of animals that wear such an animal collar, in particular in road traffic, is significantly increased. The possibility of non-reversible fastening of the reflector to the animal collar containing an active substance prevents reflectors that are possibly contaminated with active substance from becoming available and, for example, getting into the hands, or mouths, of children.

### FIGURES AND EXAMPLES

The figures show

FIG. 1 shows an exploded drawing with the individual components of the reflector

FIG. 2 shows the reflector in the closed state

FIG. 3 shows the reflector in the not yet closed state

FIG. 4 shows a side view of the mounted reflector

FIG. 5 shows a collar with reflectors mounted on it

FIGS. 6 and 6a show a section through the reflector in the region of the closure chamber

FIG. 7 shows a further side view of the reflector.

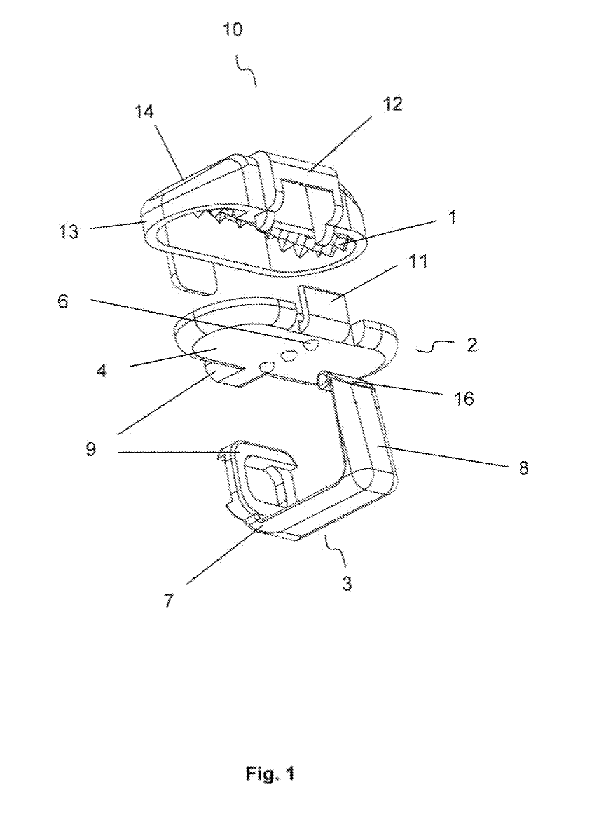

FIG. 1 shows an exploded drawing with the individual components of the reflector 10. The reflector 10 is made up of a base plate 2 with an inner surface 4 and an outer surface 5 (see FIG. 7) and a clip 3, which is substantially U-shaped and runs over the inner surface 4. On the outer surface 5 of the base plate 2 there are triple prisms. The triple prisms 1 are arranged in a frame 13, which joins flush with the periphery of the base plate 2. The triple prisms 1 form a planar reflector surface 14 with their smooth side. On the surface 4 of the base plate 2 there is/are one or more nubs 6.

The end of the first leg 7 of the clip 3 is fastened by means of a movable connection 9 to a first side of the base plate 2. In the example shown, the movable connection comprises two loops engaging one in the other. The end of the second leg 8 is suitable for being irreversibly fastened to a side of the base plate 2 opposite from the first side. The end of the second leg 8 has a closure hook 16. By interaction of the closure hook 16 with the shackle 11 fastened to the base plate 2 and the closure chamber 12 fastened to the frame 13, the leg 8 is irreversibly fastened to the base plate 2 when closure takes place.

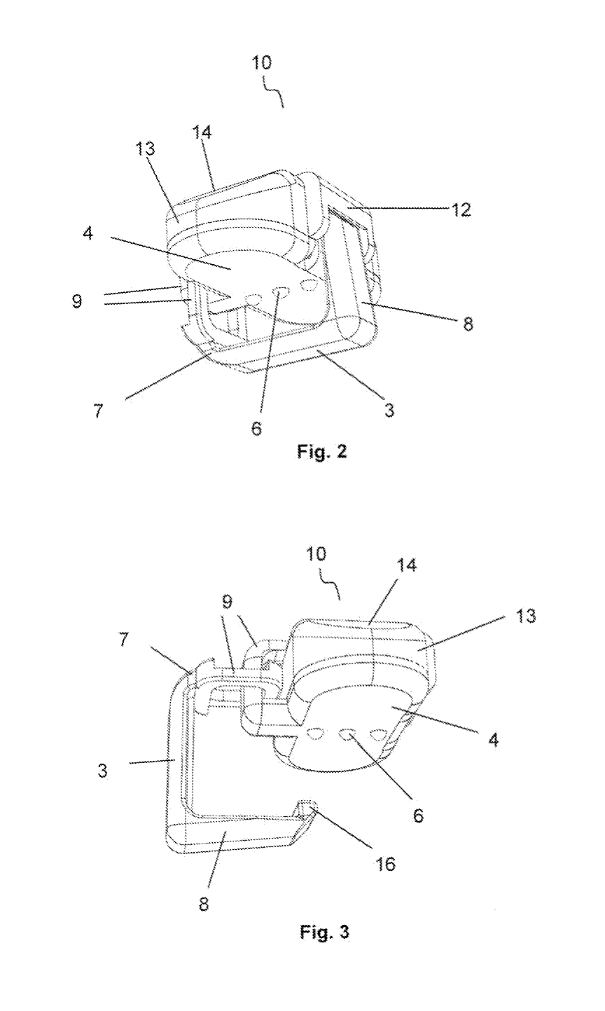

FIG. 2 shows the reflector 10 in the closed state. The closure hook 16 cannot be seen, since it is hooked with the shackle 11 inside the closure chamber 12.

FIG. 3 shows the reflector in the not yet closed state. The two loops, on the frame 13 and at the end of the leg 7 of the clip 3, engage one in the other and form the movable connection 9.

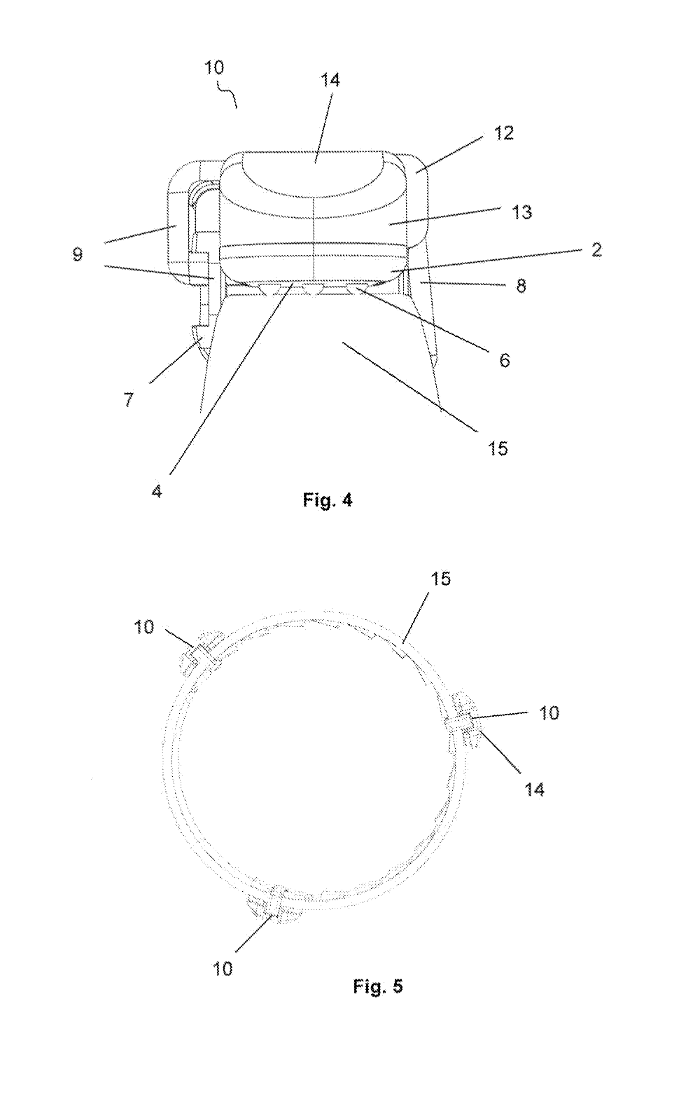

FIG. 4 shows a reflector 10, which is mounted on a collar 15. The nubs 6 bring about a distance between the inner side 4 of the base plate 2 and the collar 15 and at the same time prevent the reflector 10 from slipping on the collar 15. In the case of a collar 15 containing an active substance, the distance between the base plate 2 and the collar 15 also allows active substance to be released unhindered from the collar 15 in this direction.

FIG. 5 shows a closed collar 15 with three reflectors 10 mounted on it. The three reflectors 10 are respectively mounted spaced apart 120 degrees, in order to ensure reflection of light from all possible directions.

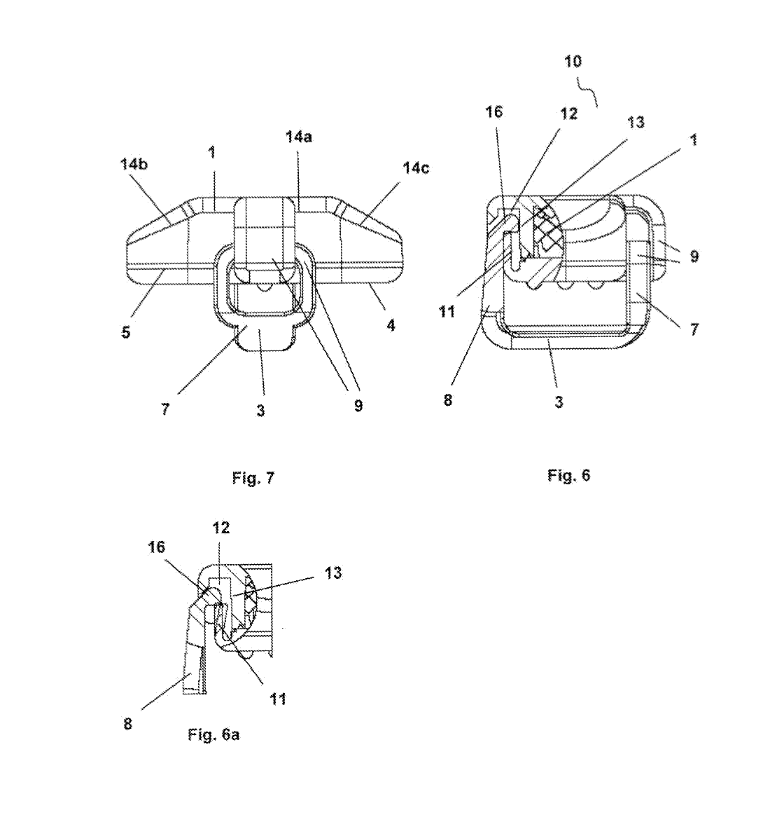

FIGS. 6 and 6a show a section through the reflector in the region of the closure chamber. When closure takes place, the closure hook 16 is inserted into the closure chamber 12 by pressing of the leg 8. The shackle 11 is in this case pressed inwards with respect to the frame 13 until the closure hook 16 has overcome the end of the shackle 11. The shackle 11 returns to its starting position under the closure hook 16. The closure hook 16 then cannot be opened again, since the shackle 11 prevents the closure hook 16 from moving downwards out of the closure chamber 12. The bevelled guide of the closure chamber 12 prevents the closure hook 16 from moving horizontally.

FIG. 7 shows the reflector from one side. The base plate 2 has nubs 6 on its inner side 4 and the frame 13 on its outer side 5. The triple prisms 1 are arranged in the frame 13, which joins flush with the periphery of the base plate 2. The triple prisms 1 form a planar reflector surface 14 with their smooth side. The reflector surface is segmented in a direction perpendicular to the path of the clip 3. The reflector surface 14 runs over the outer surface of the base plate 5 and has the greatest distance from the outer surface 5 of the base plate 2 in the middle with respect to the path perpendicular to the clip 3. The segmented reflector surface 14 comprises a middle part 14a, which runs parallel to the base plate 3, as well as two side surfaces 14b, 14c, which are symmetrical to each other, laterally join the middle part 14a and taper at an angle of 60° from the connecting point to the base plate 2.

1. Reflector (10) with a fastening device for an animal collar (15) including
a base plate (2) with an inner surface (4) and an outer surface (5) with one or more spacers (6) on the inner surface (4) and triple prisms (1) on the outer surface;
a clip (3), which is substantially U-shaped and runs over the inner surface (4), the end of the first leg (7) of the clip (3) being fastened by means of a movable connection (9) to a first side of the base plate (2), and the end of the second leg (8) of the clip (3) being suitable for being irreversibly fastened to a side of the base plate (2) opposite from the first side.

2. Reflector (10) according to claim 1, characterized in that the triple prisms (1) are arranged in a frame (13) which joins flush with the periphery of the base plate (2) and along a reflective surface (14).

3. Reflector (10) according to claim 2, characterized in that the reflector surface (14) is curved or segmented in a direction perpendicular to the path of the clip (3) and the reflector surface (14) has the greatest distance from the outer surface (5) of the base plate (2) in the middle with respect to the path perpendicular to the clip (3).

4. Reflector (10) according to claim 3, characterized in that the reflector surface (14) has a middle part (14a), which runs parallel to the base plate (2), and two side surfaces (14b, 14c), which are symmetrical to each other, laterally join the middle part (14a) and taper at an angle of 60° from the connecting point to the base plate (2).

5. Reflector (10) according to claim 1, characterized in that the triple prisms (1) are made of thermoplastic material, with preference of polycarbonate, polymethyl methacrylate, polypropylene or polyamide.

6. Reflector (10) according to claim 1, characterized in that the spacers (6) are nubs.

7. Reflector (10) according to claim 1, characterized in that the movable connection (9) comprises two loops, one engaging in the other.

8. Reflector (10) according to claim 2, characterized in that the second leg (8) of the clip (3) is suitable for being irreversibly fastened to the base plate (2) by interaction of a closure hook (16) arranged at the end of the second leg (8) with a shackle (11) fastened to the base plate (2) and a closure chamber (12) fastened to the frame (13).

9. Animal collar (15) containing an active substance which can leave the collar (15) over the entire length, at least one, with preference three, with particular preference four, of the reflectors (10) according to claim 1 being fastened to the collar (15).

10. Animal collar (15) according to claim 9, characterized in that three reflectors (10) are fastened to the animal collar (15), spaced apart from one another when the animal collar (15) is closed in the range from 100 to 140 degrees, with particular preference in the range from 118 to 122 degrees.

11. Animal collar (15) according to claim 9, characterized in that four reflectors (10) are fastened to the animal collar (15), spaced apart from one another when the animal collar (15) is closed in the range from 80 to 100 degrees, with particular preference in the range from 88 to 92 degrees.

12. Animal collar (15) according to claim 9, characterized in that the animal collar (15) consists of plastic in which there is embedded an active substance which is released by motion.

13. Animal collar (15) according to claim 12, characterized in that the plastic is PVC.

14. System comprising an animal collar (15) containing an active substance which can leave the animal collar (15) over the entire length, and at least one, with preference three, with particular preference four, of the reflectors (10) according to claim 1.

15. System according to claim 14, characterized in that the animal collar (15) consists of plastic in which there is embedded active substance which is released by motion.

16. System according to claim 15, characterized in that the plastic is PVC.
